(19) United States
(12) Patent Application Publication
(10) Pub. No.: US 2014/0302436 A1
(43) Pub. Date: Oct. 9, 2014

(54) CONTINUOUS WAX DISPERSION PRODUCTION PROCESSES

(71) Applicant: XEROX CORPORATION, Norwalk, CT (US)

(72) Inventors: Joo T. Chung, Webster, NY (US); Chieh-Min Cheng, Rochester, NY (US); Steven M. Malachowski, East Rochester, NY (US); Eric David Godshall, Macedon, NY (US); Ronald Dean Werner, Webster, NY (US)

(73) Assignee: Xerox Corporation, Norwalk, CT (US)

(21) Appl. No.: 13/856,641

(22) Filed: Apr. 4, 2013

(51) Int. Cl. G03G 9/08; G03G 9/12

(52) U.S. Cl. CPC G03G 9/0804; G03G 9/12
USPC 430/113; 430/137.14

(57) ABSTRACT

Processes for continuously producing a wax dispersion are disclosed. A multi-screw extruder is used for the processes. A wax and a surfactant are fed into the extruder and melted together. Water is then added to form a dispersion. The wax particles are homogenized and exit the extruder to be passed through a quenching unit. The wax dispersion can be used to make toner compositions.

### BACKGROUND

The present disclosure relates to continuous processes for producing wax dispersions. Such dispersions are used for producing toner compositions, and can be considered to be “green” processes due to their reduced energy consumption.

Toner compositions are used with electrostatographic, electrophotographic or xerographic print or copy devices. In such devices, an imaging member or plate comprising a photoconductive insulating layer on a conductive layer is imaged by first uniformly electrostatically charging the surface of the photoconductive insulating layer. The plate is then exposed to a pattern of activating electromagnetic radiation, for example light, which selectively dissipates the charge in the illuminated areas of the photoconductive insulating layer while leaving behind an electrostatic latent image in the non-illuminated areas. This electrostatic latent image may then be developed to form a visible image by depositing finely divided electroscopic toner particles, for example from a developer composition, on the surface of the photoconductive insulating layer. The resulting visible toner image can be transferred to a suitable receiving substrate such as paper.

Processes for forming toner compositions are known. For example, emulsion/aggregation (E/A) processes involve preparing an emulsion of toner ingredients such as latex, a surfactant, a colorant, and wax in water. The emulsion is heated to a temperature below the latex Tg to form aggregates. The pH is then raised by addition of a base and the emulsion is heated to a temperature above the latex Tg to coalesce the aggregates, followed by lowering the pH to fuse the particles. Washing of the resulting product, and then isolating the toner particles, completes the process.

Waxes are added to toner formulations in order to aid toner release from the fuser roll, particularly in low oil or oil-less fuser designs. To incorporate the wax into the toner, it is necessary for the wax to be in the form of an aqueous emulsion or dispersion of solid wax in water, where the solid wax particle size is usually in the range of from about 100 to about 500 nm.

Current processes for forming wax dispersions are generally performed as batch processes. Batch processes generally require a long cycle time between batches. It can be difficult to control the particle size and circularity consistently between lots. Batches are made in volumes of thousands of gallons at a time. Malfunction of the control system during a batch E/A process can result in the entire batch not meeting specification and thus being considered waste. Also, batch processes are generally labor-intensive and require a great deal of equipment, inventory, and storage space due to their long cycle time. The use of solvents can also cause environmental concerns.

It would be desirable to provide processes that allow for the preparation of wax dispersions in a manner that is more efficient, takes less time, results in a consistent product, and reduces waste volumes.

### BRIEF DESCRIPTION

The present disclosure relates to continuous processes for producing wax dispersions using a multi-screw extruder. Generally, a wax and a surfactant are fed into the extruder and a wax dispersion exits the extruder.

Disclosed in various embodiments is a continuous process for producing a wax dispersion, comprising: feeding a wax and a surfactant into a first zone of a multi-screw extruder; melting the wax in a second zone of the extruder; adding water to the wax in a third zone of the extruder to form a dispersion containing wax particles dispersed in the water; homogenizing the wax particles in a fourth zone of the extruder, and pumping the wax dispersion from an outlet port of the multi-screw extruder.

The local residence time in the first zone may be from about 0.05 minute to about 0.15 minute. The local residence time in the second zone may be from about 0.5 minute to about 1 minute. The local residence time in the third zone may be from about 0.6 minute to about 1.3 minutes. The local residence time in the fourth zone may be from about 0.5 minute to about 1 minute.

The temperature in the first zone may be from about 30° C. to about 50° C. The temperature in the second zone may be from about 80° C. to about 155° C. The wax dispersion exits the third zone at a temperature of from about 80° C. to about 155° C. The temperature in the fourth zone may be from about 80° C. to about 155° C.

The wax may be a polyethylene wax or a polymethylene wax. The surfactant may be an anionic surfactant. The multi-screw extruder may be a twin-screw extruder. The screws in the extruder may rotate at a speed of about 50 rpm to about 400 rpm.

Also disclosed is a wax dispersion, produced by: feeding a wax and a surfactant into a first zone of a multi-screw extruder; melting the wax in a second zone of the extruder; adding water to the wax in a third zone of the extruder to form a dispersion containing wax particles dispersed in the water; homogenizing the wax particles in a fourth zone of the extruder; and pumping the wax dispersion from an outlet port of the multi-screw extruder.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a schematic diagram showing a multi-screw extruder suitable for use in the continuous processes of the present disclosure.

FIG. 2 provides axial and profile views illustrating the differences between single-lobe, two-lobe, and three-lobe screws.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

A value modified by a term or terms, such as “about” and “substantially,” may not be limited to the precise value specified. The approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.”

The continuous processes disclosed herein are used to produce wax dispersions. Generally, a wax and a surfactant are fed into a first zone of a multi-screw extruder. The wax is melted in a second zone of the extruder. Water is added to the wax in a third zone of the extruder to form a dispersion of wax particles in water. The wax particles are homogenized in a fourth zone of the extruder, and then exit the extruder as a wax dispersion.

A wax dispersion may also be referred to as a “wax emulsion” in the industry, these two terms being synonymous and referring to the same entity. Emulsions, by the classical definition, are mixtures of two immiscible liquids stabilized by an emulsifier. By this classical definition, in the case of wax, an emulsion technically exists only when the wax is in its molten state as the emulsion is formed. However, the terminology “wax emulsion” has become widely used in the industry to describe also the final product, and so is used in this same manner in the present disclosure, that is, in the manner accepted within the industry.

In contrast, in current batch processes, a surfactant solution is prepared in a heated and pressurized tank. Wax is melted in a separated heated and pressurized tank, then added to the surfactant solution. The wax/surfactant solution must then pass through a high pressure homogenizer for a long time period, and is then cooled in a heat exchanger.

The continuous process using a multi-screw extruder is simpler than producing the wax dispersion using batch processes. Many process steps can be eliminated. Because the continuous process is simpler, production costs are lower. Because smaller quantities of material are processed at a time, quality control is easier. If process controls malfunction during the continuous process, a smaller quantity of non-specification material is produced that must be discarded. Lot-to-lot variation can be reduced as well due to the control of temperature and other process parameters in small segments along the length of the extruder. In contrast, many process controls for a reaction vessel used in a batch process can only be provided along the surface of the reaction vessel. This causes significant large inhomogeneities between the material near the sides of the reaction vessel and the material in the center of the reaction vessel, such as in the temperature gradient, shear rate gradient, the velocity profile, pumping capacity, and viscosity differences. As a result, a long time period is needed for the material in the reactor vessel to be homogenized.

The Wax Dispersion

The processes of the present disclosure use a multi-screw extruder, such as a twin screw extruder. During the process, a wax and a surfactant are fed into the extruder. In this section, these ingredients are described. In a later section, the processes are further described with reference to the extruder.

The wax used in the wax dispersion may be a natural vegetable wax, natural animal wax, mineral wax and/or synthetic wax. Examples of natural vegetable waxes include, for example, carnauba wax, candelilla wax, Japan wax, and bayberry wax. Examples of natural animal waxes include, for example, beeswax, punic wax, lanolin, lac wax, shellac wax, and spermaceti wax. Mineral waxes include, for example, paraffin wax, microcrystalline wax, montan wax, ozokerite wax, ceresin wax, petrolatum wax, and petroleum wax. Synthetic waxes of the present disclosure include, for example, Fischer-Tropsch wax, acrylate wax, fatty wax, polypropylene wax, and mixtures thereof. acid amide wax, silicone wax, polytetrafluoroethylene wax, polyethylene wax, polymethylene

Examples of polypropylene and polyethylene waxes include those commercially available from Allied Chemical and Baker Petrolite, wax emulsions available from Michelman Inc. and the Daniels Products Company, EPOLENE N-15 commercially available from Eastman Chemical Products, Inc., Viscol 550-P, a low weight average molecular weight polypropylene available from Sanyo Kasel K.K., and similar materials. In embodiments, commercially available polyethylene waxes possess a molecular weight (Mw) of from about 1,000 to about 1,500, and in embodiments of from about 1,250 to about 1,400, while the commercially available polypropylene waxes have a molecular weight of from about 4,000 to about 5,000, and in embodiments of from about 4,250 to about 4,750.

In specific embodiments of the present disclosure, the wax is a polyethylene wax or a polymethylene wax. The polyethylene wax desirably has a peak melting point in the range of from about 80° C. to about 120° C. and an onset melting point in the range of from about 60° C. to about 100° C. as measured, for example, by differential scanning calorimetry (DSC). The morphology of the wax contained in the emulsion is desirably semi-crystalline, wherein the degree of crystallinity ranges from about 50 to about 99% by weight of the wax as measured by DSC.

In embodiments, the waxes may be functionalized. Examples of groups added to functionalize waxes include amines, amides, imides, esters, quaternary amines, and/or carboxylic acids. In embodiments, the functionalized waxes may be acrylic polymer emulsions, for example, Joncryl 74, 89, 130, 537, and 538, all available from Johnson Diversey, Inc, or chlorinated polypropylenes and polyethylenes commercially available from Allied Chemical and Petrolite Corporation and Johnson Diversey, Inc.

The surfactant may be an anionic, cationic, and/or nonionic surfactant. Anionic surfactants which may be utilized include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abitic acid, combinations thereof, and the like. Other suitable anionic surfactants include, in embodiments, DOWFAX® 2A1, an alkyldiphenyloxide disulfonate from The Dow Chemical Company, and/or TAYCA POWER BN2060 from Tayca Corporation (Japan), which are branched sodium dodecyl benzene sulfonates. Combinations of these surfactants and any of the foregoing anionic surfactants may be used.

Examples of nonionic surfactants include, but are not limited to alcohols, acids and ethers, for example, polyvinyl alcohol, polyacrylic acid, methalose, methyl cellulose, ethyl cellulose, propyl cellulose, hydroxylethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonyiphenyl ether, dialkylphenoxy poly(ethyleneoxy) ethanol, mixtures thereof, and the like.

Examples of cationic surfactants include, but are not limited to, ammoniums, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, and C12, C15, C17 trimethyl ammonium bromides, mixtures thereof, and the like. Other cationic surfactants include cetyl pyridinium bromide, halide salts of quatemized polyoxyethylalkylamines, dodecylbenzyl triethyl ammonium chloride, and the like, and mixtures thereof. The choice of particular surfactants or combinations thereof as well as the amounts of each to be used are within the purview of those skilled in the art.

Continuous Wax Dispersion Production Process

The continuous processes of the present disclosure begin with feeding a wax and a surfactant into a multi-screw extruder. A multi-screw extruder includes a segmented barrel and at least two screw elements extending lengthwise through the barrel. Each segment of the barrel can be heated and controlled at a set temperature independently of the other barrel segments, and functions as a continuous small reaction vessel or reactor. The screw elements in each segment can also be varied for the particular application. The local residence time in each segment can be lengthened or shortened, the mixing intensity can be adjusted, and the shear stress and shear rate profiles can be optimized through screw design. The local pressure and volume can also be changed within each segment of the barrel through screw design. The screw speed and particle slurry feed rate can be controlled during the continuous process. Such an extruder permits many different applications, such as melt-mix, distributive mixing, dispersive mixing, dissipative missing, and chaotic mixing.

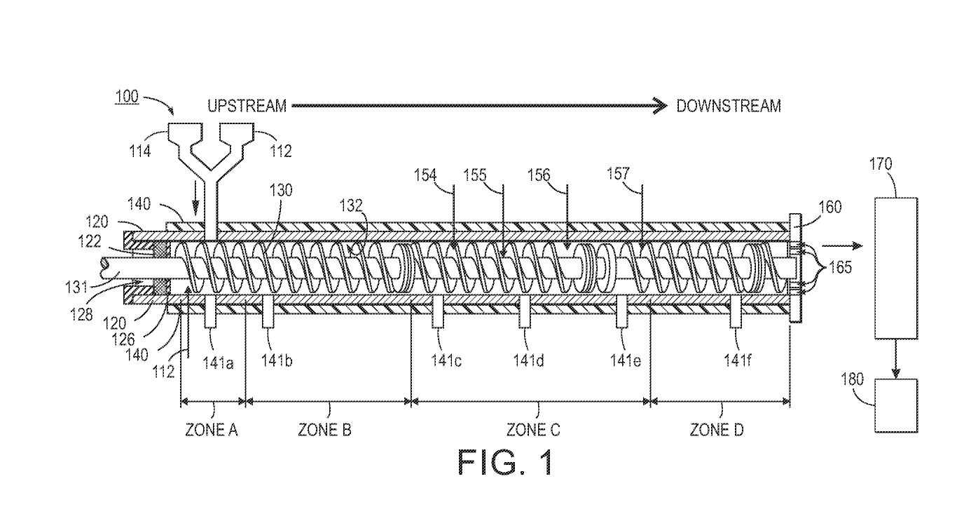

Referring now to FIG. 1, the multi-screw extruder 100 includes an extruder barrel 120, at least two screws 130, a screw extruder channel 132, a heater 140, thermocouple 141, a surfactant feeder 112; a wax feeder 114, and water supply ports 154. Each screw 130 is driven by a shaft 131 which is connected to a drive motor (not shown) in a conventional manner that allows for rotation of screw 130 at speeds of from about 50 rotations per minute (“rpm”) to about 1000 rpm, or in more specific embodiments from about 250 rpm to about 750 rpm, or from about 50 rpm to about 400 rpm. Slower speeds reduce wear and tear on the equipment. Each shaft 131 passes through liquid seal housing 128, blister ring 122, and seal pack 126, which seals the upstream end of barrel 120.

The screw extruder 100 is divided into four zones; namely Zone A (first zone) where the wax and surfactant are fed into the extruder, Zone B (second zone) where the wax is melted, Zone C (third zone) where water is added to form a dispersion, and Zone D (fourth zone) where particle homogenization takes place. Zone A is upstream of Zone B, which is upstream of Zone C, which is upstream of Zone D. As previously mentioned, the barrel is separated into segments; each zone includes at least one segment, and may include a plurality of segments. Each zone includes a thermocouple 141a, 141b, 141c, 141f for monitoring and controlling the temperature of the zone. Material moves from the upstream end of the extruder 100 in the downstream direction sequentially through Zones A, B, C, and D eventually exiting the extruder 100 through openings 165 of head 160. The surfactant feeder 112 and the wax feeder 114 are located in Zone A. The water supply ports 154 are located in Zone C.

Each screw 130 can be modular in construction in the form of pieces of conveying elements, enabling the screw to be configured with different conveying elements and kneading elements having the appropriate lengths, pitch angles, and the like, in such a way as to provide optimum conveying, mixing, dispersing, devolatilizing, discharging, and pumping conditions. For example, each conveying element may have a length of from about 1350 mm to about 3000 mm, and a pitch angle of from about 0° to about 90°. In more particular embodiments, each conveying element has a length from about 1500 mm to about 2500 mm, and a pitch angle of from about 20° to about 75°. Kneading elements may be affixed to the screw, or the kneading elements may be integral thereto and project therefrom. Kneading elements may have any suitable shape, size, and configuration, including right and left hand kneading elements and neutral kneading elements with the helix angle of the kneading elements being from about 45° to about 90°, combinations thereof, and the like. The kneading elements may be forward, neutral, and/or reverse kneading elements. Put another way, they may push the particles through the extruder toward the outlet port (forward), back through the extruder toward the inlet port (reverse), or they may knead the aggregated/coalesced particles without actively forwarding or reversing the components through the extruder (neutral).

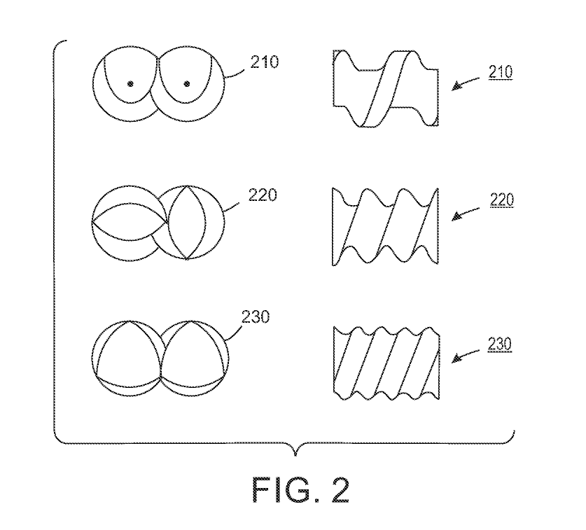

FIG. 2 provides a axial view (on the left) and a profile view (on the right) for three different types of conveying/kneading elements that can be used in a multi-screw extruder. Illustrated here are a single lobe screw 210, a two-lobe screw 220, and a three-lobe screw 230. As the number of lobes increases, the element generates higher shear and shear stress, as well as increasing residence time of the material in the system for a given screw speed and set of process conditions. A three-lobe screw generates higher viscous dissipation heat due to high shear stress and shear rate, and is more effective for a dissipative melt mixing in the segment in which it is used. A three-lobe screw has less free volume and results in lower throughput, which in turn, lowers productivity compared to a two-lobe screw. Thus, a two-lobe screw has higher free volume and increases productivity. A two-lobe screw may also effectively be used as an equivalent to the three-lobe screw by changing the process conditions without jeopardizing productivity.

The local residence time in each of Zones A, B, C, and D can be controlled by screw design, screw speed, feed rates, temperature and pressure. The local residence time suitable for the continuous coalescence processes will vary depending on a number of factors including, for example, the particular latex employed, the temperature within the zone, the length of the zone, etc. The screw extruder should be designed to provide local residence times of from about 0.05 minutes to about 0.15 minutes in Zone A; from about 0.5 minutes to about 1 minute in Zone B; from about 0.6 minutes to about 1.3 minutes in Zone C; and from about 0.5 minutes to about 1 minute in Zone D. In embodiments, the total residence time of the slurry within the multi-screw extruder is from about 1.65 minutes to about 3.45 minutes.

Initially, the wax is fed into the barrel 120 of the extruder via the wax feeder 114, and the surfactant is fed via the surfactant feeder 112. They are fed into Zone A. The wax is usually provided in the form of pellets, and can be fed into the barrel at a controlled volumetric rate of 1 to 20 kg/hour, or at a pressure of from about 5.0 psi to about 100 psi. The surfactant is provided as a powder, i.e. in dry form, which eliminates an extra process step and increases productivity. The amount of surfactant is not critical, and often depends on the structure of the surfactant itself. As a general guideline, the amount of surfactant needed to produce a stable wax emulsion is in the range of from about 0.1 to about 15 parts per hundred surfactant-to-wax (w/w), preferably from about 1.0 to about 5.0 parts per hundred surfactant-to-wax. The temperature in Zone A is set in a range of from about 30° C. to about 50° C., and below the melting temperature of the wax.

In Zone B, the wax is melted by raising the temperature in Zone B above the melting point of the wax. The temperature is usually at least 10° C. higher than the melting point, and usually about 15° C. to about 35° C. above the melting point. In embodiments, the temperature in Zone B can be in the range of from about 80° C. to about 155° C.

In Zone C, water is added to the melted wax to form a dispersion. As illustrated here, multiple water supply ports 154, 155, 156, 157 are located along the length of Zone C. The initial addition of water results in the formation of a “water-in-wax” dispersion, where the water is the dispersed phase and the wax is the continuous phase. As additional water is added downstream, phase inversion occurs so that the wax forms particles and becomes the dispersed phase, and the water becomes the continuous phase. The surfactant stabilizes the dispersion and reduces/prevents agglomeration of the wax particles.

The morphology of the wax particles contained in the wax dispersion depends upon the conditions under which the molten wax is cooled, and more specifically on the cooling rate of the wax. Wax crystallites will form as the molten wax is cooled. Faster cooling of the molten wax generally results in a lower degree of crystallinity and smaller sized crystallites. As such, it is helpful to understand how wax emulsions are formed. The cooling rate can be controlled via many different parameters. For example, the temperature of the water added via the water supply ports 154, 155, 156, 157 can decrease going downstream (e.g. water from port 154 is warmer than water from port 157). The rate at which water is added can differ between the water supply ports. The barrel temperature of each segment within Zone C can also differ. A general cooling rate of from about 10 to about 20° C./min is desired. Zone C may contain multiple thermocouples 141c, 141d, 141e to monitor this change in temperature. The temperature range in Zone C may be the same as that of Zone B.

In Zone D, the particles are homogenized. The term “homogenizing” is used to generally refer to the process of ensuring that particles are consistently dispersed or suspended throughout a liquid. The wax particles are processed to arrive at a wax dispersion having a desired particle size distribution and having a high degree of circularity. Zone D can operate at a temperature range of from about 80° C. to about 155° C.

The wax dispersion is then pumped from Zone D of the screw extruder and exits the extruder through the openings 165 at the head 160 of the extruder. A positive displacement pump, such as a gear pump, can be used for this purpose to control the pump rate and regulate the back pressure. If desired, the wax dispersion can pass through a quenching unit 170 that cools the dispersion to a temperature of from about 20° C. to about 40° C. The wax dispersion is collected in a receiving tank 180.

The resulting wax particles have an average diameter (i.e. D₅₀) ranging from about 50 nanometers (nm) to about 500 nm, or in more specific embodiments a diameter of less than 100 nm. The particle diameter at which a cumulative percentage of 50% (by number) of the total toner particles are attained is defined as the D₅₀. In other words, 50% of the particles have a diameter above the D₅₀, and 50% of the particles have a diameter below the D₅₀. Similarly, the particle diameter at which a cumulative percentage of 95% of the total toner particles are attained is defined as the D₉₅. The volume average particle diameter (MV) represents the center of gravity of the particle size distribution, and is the diameter of the average particle based on the volume. The number average particle diameter (MN) is the diameter of the average particle taking into account the distribution of particle sizes. Note that these values will differ depending on the distribution of large particles and small particles.

The final wax dispersion contains from about 5 wt % to about 50 wt % of solids, and contains from about 50 wt % to about 95 wt % of water.

The continuous processes of the present disclosure minimize vulnerability of the process to control system malfunctions and reduce the amount of wasted product. If a malfunction occurs, only a small amount of the dispersion must be discarded, rather than thousands of gallons as in batch processes. Only the non-specification dispersion needs to be purged. The extruder can be easily cleaned, and the rest of the system can continue. This results in decreased cycle time, increased productivity, and reduced cost. Consistency between production lots is also increased. The process is less labor-intensive and uses less equipment. The wax dispersion can be produced in a just-in-time manner, which minimizes inventory and storage space as well. In addition, the continuous processes disclosed herein are volumetrically more efficient than a batch process, requiring a smaller operating footprint for an equivalent operating rate.

The following examples are for purposes of further illustrating the present disclosure. The examples are merely illustrative and are not intended to limit the disclosure to the materials, conditions, or process parameters set forth therein.

### EXAMPLE

A continuous process using a twin-screw extruder was used to produce a samples. A polymethylene wax was used with a TAYCA® surfactant provided in powder form. The melting point of the wax was 91±2° C. The wax and surfactant were fed at a controlled rate into the extruder. The wax was melted and mixed with the surfactant for pre-emulsification, then missed with water to obtain the dispersion. The screw speed was 350 rpm, and the solids content of the dispersion was 30.4%. The temperature in Zone A was set at 40° C. to prevent premature melting. The temperature in Zone B was set at 105° C. The temperature in Zone C was 105° C. The temperature in Zone D was 105° C. Deionized water was injected at the upstream end of Zone C at a rate of 30 g/min, then 57 g/min further downstream, then 80 g/min further downstream.

As a Comparative Example, a batch process was used. Table 1 lists the results comparing the two processes. The continuous processes of the present disclosure provided a tighter particle size distribution, as reflected in the smaller difference between the MV and the MN.

TABLE 1

| | | | | | Solids | |
|---|---|---|---|---|---|---|
| Example | D50 (nm) | D95 (nm) | MV (nm) | MN (nm) | Content (%) | Tm (° C.) |
| Control | 219.5 | 388 | 231.9 | 164.8 | 30 | 91 ± 2 |
| Continuous | 208.6 | 323 | 216.6 | 178.5 | 30.4 | 90.8 |

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A continuous process for producing a wax dispersion, comprising:
feeding a wax and a surfactant into a first zone of a multi-screw extruder;
melting the wax in a second zone of the extruder;
adding water to the wax in a third zone of the extruder to form a dispersion containing wax particles dispersed in the water;
homogenizing the wax particles in a fourth zone of the extruder; and
pumping the wax dispersion from an outlet port of the multi-screw extruder.

2. The process of claim 1, wherein the local residence time in the first zone is from about 0.05 minute to about 0.15 minute.

3. The process of claim 1, wherein the local residence time in the second zone is from about 0.5 minute to about 1 minute.

4. The process of claim 1, wherein the local residence time in the third zone is from about 0.6 minute to about 1.3 minutes.

5. The process of claim 1, wherein the local residence time in the fourth zone is from about 0.5 minute to about 1 minute.

6. The process of claim 1, wherein the temperature in the first zone is from about 30° C. to about 50° C.

7. The process of claim 1, wherein the temperature in the second zone is from about 80° C. to about 155° C.

8. The process of claim 1, wherein the wax dispersion exits the third zone at a temperature of from about 80° C. to about 155° C.

9. The process of claim 1, wherein the temperature in the fourth zone is from about 80° C. to about 155° C.

10. The process of claim 1, wherein the wax is a polyethylene wax or a polymethylene wax.

11. The process of claim 1, wherein the surfactant is an anionic surfactant.

12. The process of claim 1, wherein the multi-screw extruder is a twin-screw extruder.

13. The process of claim 1, wherein screws in the extruder rotate at a speed of about 50 rpm to about 400 rpm.

14. The process of claim 1, wherein the surfactant is added as a powder.

15. A wax dispersion, produced by:
feeding a wax and a surfactant into a first zone of a multi-screw extruder;
melting the wax in a second zone of the extruder;
adding water to the wax in a third zone of the extruder to form a dispersion containing wax particles dispersed in the water;
homogenizing the wax particles in a fourth zone of the extruder; and
pumping the wax dispersion from an outlet port of the multi-screw extruder.
